(19) United States
(12) Patent Application Publication
(10) Pub. No.: US 2023/0221620 A1
(43) Pub. Date: Jul. 13, 2023

(54) OPTICAL ELEMENT HAVING STRAY LIGHT SUPPRESSION STRUCTURE

(71) Applicant: NEWMAX TECHNOLOGY CO., LTD., Taichung City (TW)

(72) Inventor: Yung-Fu LIANG, Taichung City (TW)

(21) Appl. No.: 18/180,147

(22) Filed: Mar. 8, 2023

Related U.S. Application Data
(63) Continuation-in-part of application No. 16/534,707, filed on Aug. 7, 2019.

(51) Int. Cl. G03B 11/04

(52) U.S. Cl. CPC G03B 11/04

(57) ABSTRACT

An optical element having stray light suppression structure includes: a ring body including a stray light suppression structure disposed on the inner peripheral surface thereof; the stray light suppression structure includes a plurality of stray light suppression protrusions and a plurality of stray light suppression grooves, each of the stray light suppression protrusions is a continuous structure that presents an S-shaped curve, the stray light suppression protrusions protrude from the inner peripheral surface at a same height, each of the stray light suppression protrusions includes a first stray light suppression end, a second stray light suppression end, and a connecting line passing through the first stray light suppression end and the second stray light suppression end. The connecting line does not coincide or intersect with the axis of the ring body.

### CROSS REFERENCE TO RELATED APPLICATIONS

This application is a continuation-in-part of U.S. patent application Ser. No. 16/534,707 filed on Aug. 7, 2019. The above application is incorporated by reference herein.

### BACKGROUND

### Field of the Invention

The present invention relates to an optical element, and more particularly to an optical element having stray light suppression structure.

### Description of Related Art

An optical device such as lens assembly is composed of a plurality of optical elements such as lens, spacer ring, or positioning ring. Because only part of the lens can be used for imaging, stray light is generated on the non-optical portion of the lens usually. Stray light may reduce the performance of imaging.

To avoid the stray light, rough surface is usually used to disperse light, as shown in patents TW I612354, TW I616697, TW I639029, TW201821848A, TW 201814345A, US2019/0278058, US2016/0349476, and US2022/0045471. The rough surface is formed around the optical portion or on the inner peripheral face of the spacer ring.

However, the bumps or recesses have even shapes. For example, concentric annular grooves or radial linear grooves are often used. The surface for reflecting has a specific orientation. Sometimes the surface concentrates the stray light instead. Especially in the previous patents of US2019/0278058 and US2016/0349476, the inner peripheral surface for the formation of stray light suppression structure is stepped in the axial direction, and the stray light suppression structure is not designed in the way of continuous contour along the axial direction, and also does not present the S-shaped curve design, resulting in the defect of poor stray light suppression.

### SUMMARY

One objective of the present invention is to provide an optical element having stray light suppression structure to prevent imaging from being affected by stray light.

To achieve the above objective, an optical element having stray light suppression structure provided by the invention comprises: a ring body including an axis, an inner peripheral surface surrounding the axis, an outer peripheral surface opposite the inner peripheral surface, a first ring end surface connecting the inner peripheral surface and the outer peripheral surface, a second ring end surface opposite the first ring end surface, and a stray light suppression structure disposed on the inner peripheral surface;

wherein the inner peripheral surface has an inner straight line formed by a section in the direction of the axis, and an included angle between an extension of the inner straight line and the axis is θ, and following condition is satisfied: 25°<θ<65°;

the stray light suppression structure includes a plurality of stray light suppression protrusions surrounding the axis and spaced on the inner peripheral surface, and a plurality of stray light suppression grooves formed by the inner peripheral surface and every two adjacent stray light suppression protrusions, each of the stray light suppression protrusions is a continuous structure that presents an S-shaped curve, the stray light suppression protrusions protrude from the inner peripheral surface at a same height, each of the stray light suppression protrusions includes a first stray light suppression end connecting the first ring end surface, a second stray light suppression end connecting the second ring end surface, a stray light suppression section connected between the first stray light suppression end and the second stray light suppression end, and a connecting line passing through the first stray light suppression end and the second stray light suppression end, and the connecting line does not coincide or intersect with the axis.

The effect and function of the invention are that when the optical element is installed in the lens mount and is used as a positioning ring or spacer ring, in the actual imaging process, the design of the respective stray light suppression protrusions and grooves provides a considerable number of irregular surfaces to reflect stray light, making the reflecting directions of the reflection surfaces more multidirectional, so that the stray light can be scattered more dispersedly, so as to prevent the stray light from gathering and affecting the imaging.

Preferably, the inner peripheral surface of the ring body is tapered from the first ring end surface to the second ring end surface.

Preferably, an arbitrary axial section line passes through at least two of the stray light suppression protrusions and at least two of the stray light suppression grooves.

Preferably, each of the stray light suppression protrusions includes a reverse bend point.

Preferably, the stray light suppression section of each of the stray light suppression protrusions includes a stray light suppression top surface, the stray light suppression top surface includes a first side adjacent to the first stray light suppression end, and a second side adjacent to the second stray light suppression end and opposite to the first side, a width of the stray light suppression top surface expanded then reduced from the first side to the reverse bend point, and a width of the stray light suppression top surface expanded then reduced from the second side to the reverse bend point.

Preferably, the stray light suppression section of each of the stray light suppression protrusions further includes a first stray light suppression side surface connected to one side of the stray light suppression top surface, and a second stray light suppression side surface connected to the other side of the stray light suppression top surface, and the first stray light suppression side surface and the second stray light suppression side surface are arc-shaped in cross section in a radial direction.

Preferably, a bottom surface of each of the stray light suppression grooves is arc-shaped in cross section in a radial direction.

Preferably, a bottom surface of each of the stray light suppression grooves presents a straight line in cross section in a radial direction.

Preferably, a distance between two adjacent said stray light suppression protrusions is D1, a width of the stray light suppression protrusions is D2, and the following condition is satisfied: 0.2<D1/(D1+D2)<1.0.

Preferably, a bottom surface of each of the stray light suppression grooves presents a V shape in cross section in a radial direction.

### BRIEF DESCRIPTION OF THE DRAWINGS

FIG. 1 is a stereoscopic view of a first embodiment of the invention, showing the state of the invention being installed in the lens amount;

FIG. 2 is a stereoscopic exploded view of the first embodiment of the present invention, showing the separation of the present invention from the lens amount;

FIG. 3 is a sectional view of the first embodiment of the invention, and the sectional state of the invention being installed in the lens amount;

FIG. 4 is a perspective view of the first embodiment of the present invention;

FIG. 5 is a sectional view of section 5-5 of FIG. 4;

FIG. 6A is a magnified view of a part of FIG. 5, showing that the four stray light suppression protrusions are represented by blackening;

FIG. 6B is a sectional view of section 6B-6B of FIG. 6A;

FIG. 7 is a magnified view of a part of FIG. 4;

FIG. 8A is a partial schematic diagram of the first embodiment of the present invention, which shows the three-dimensional state of the inner peripheral surface with only two stray light suppression protrusions, and is represented by blackening;

FIG. 8B is the top view of FIG. 8A;

FIG. 8C is the front view of FIG. 8A;

FIG. 9A is a stereoscopic view of a part of the second embodiment of the present invention;

FIG. 9B is a radial sectional view of a part of the second embodiment of the present invention, showing that the bottom surface of the stray light suppression concave is a straight line in cross section in the radial direction;

FIG. 10A is a stereoscopic view of a part of the third embodiment of the present invention;

FIG. 10B is a radial sectional view of a part of the third embodiment of the invention, showing the bottom surface of the stray light suppression concave presents a V shape in cross section in the radial direction.

### DETAILED DESCRIPTION

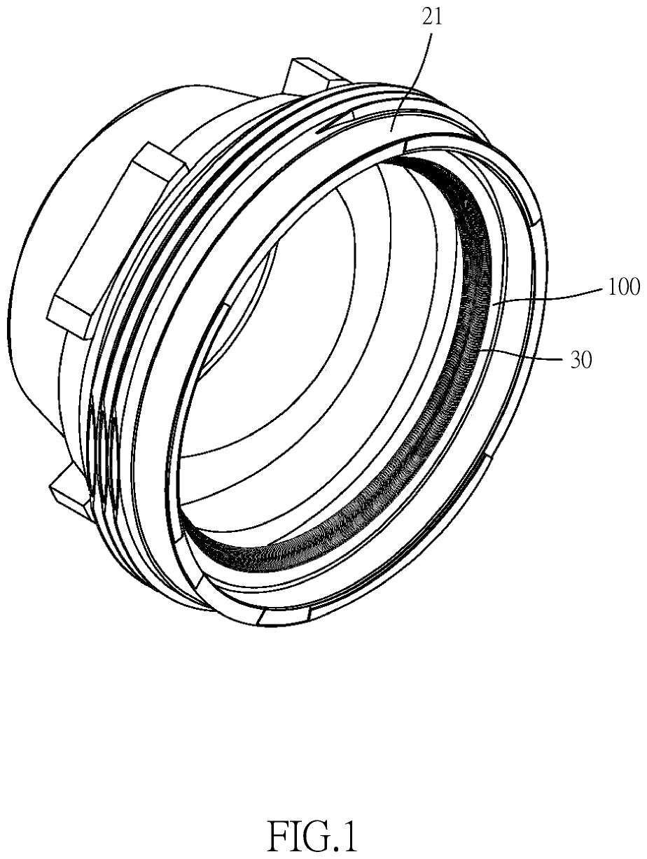

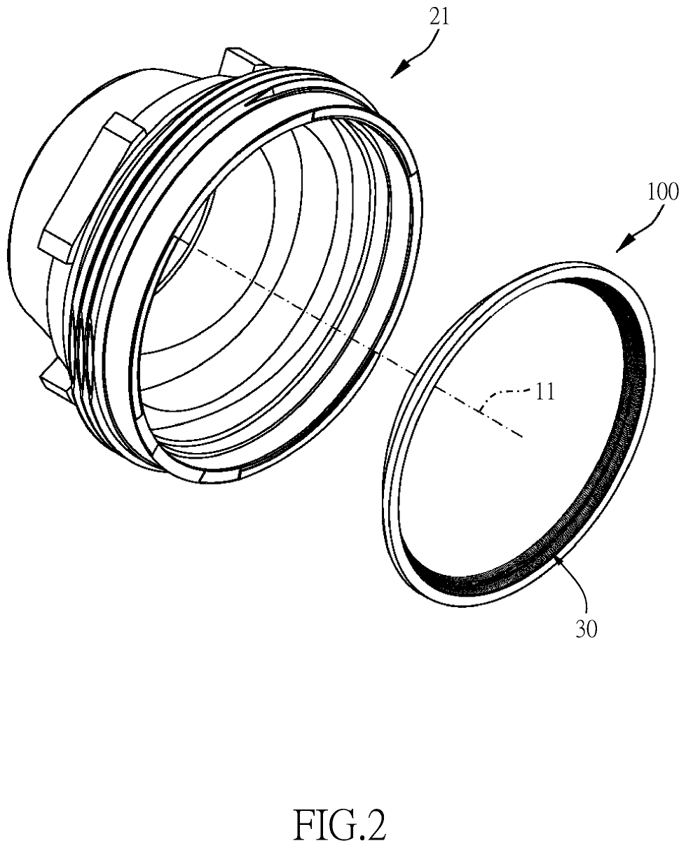

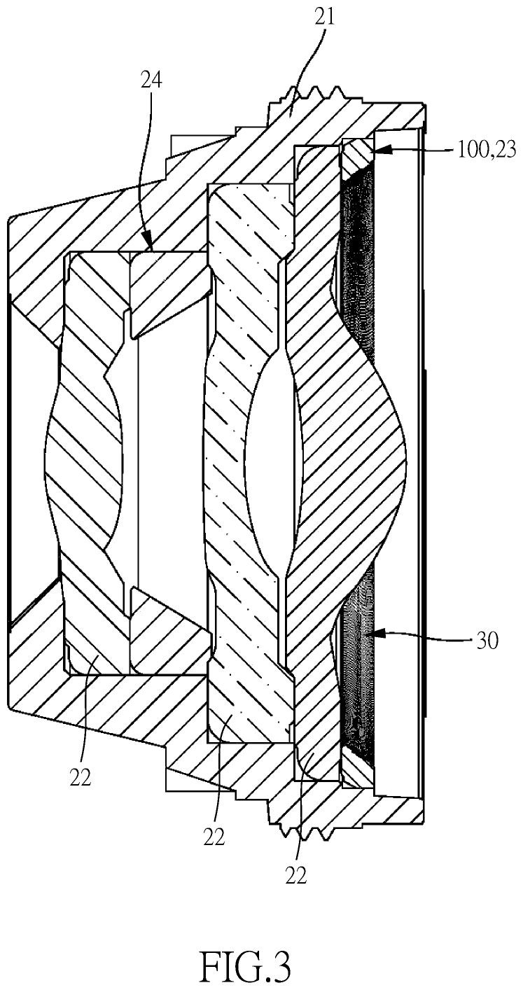

As shown in FIGS. 1 to 3, the present invention provides an optical element having stray light suppression structure. The optical element 100 is a positioning ring 23, but not limited thereto, and can also be a spacer ring 24. The optical element 100 is disposed inside a lens mount 21; As shown in FIG. 3, when the optical element 100 is located at one end of the lens mount 21 for pressing against the last lens element 22 of the lens group, the optical element 100 is used as a positioning ring 23. When the optical element 100 is disposed inside the lens mount 21 and located between two lens elements 22, the optical element 100 is used as a spacer ring 24. However, whether the optical element 100 is used as the positioning ring 23 or the spacer ring 24, it can avoid gathering stray light and affecting the imaging.

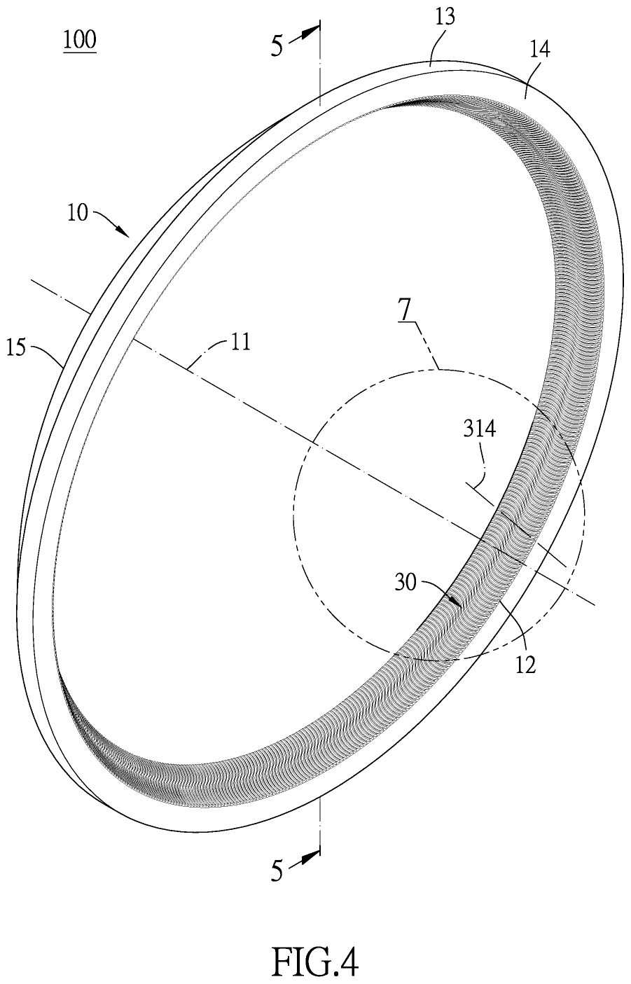

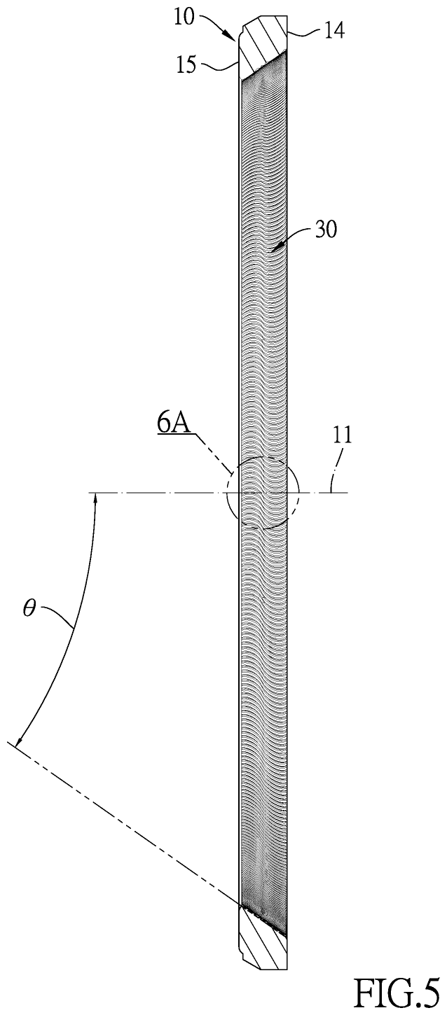

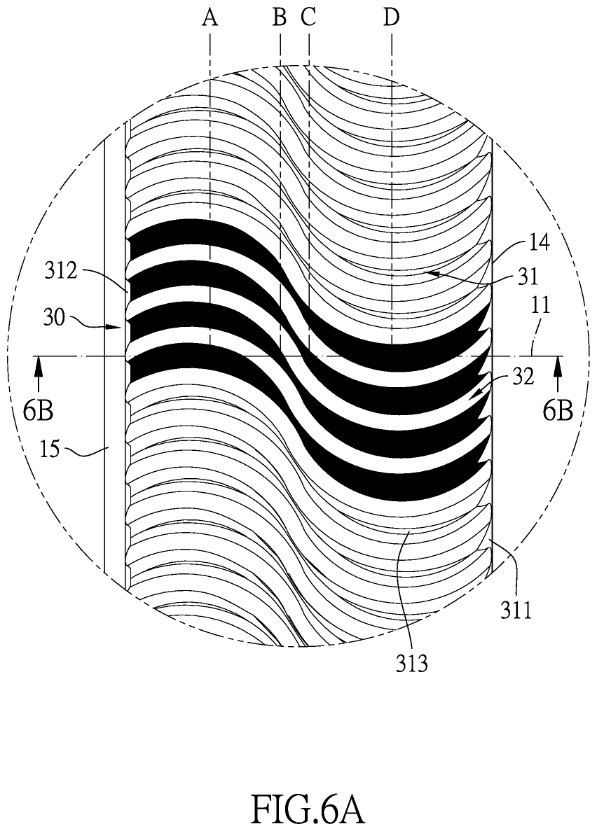

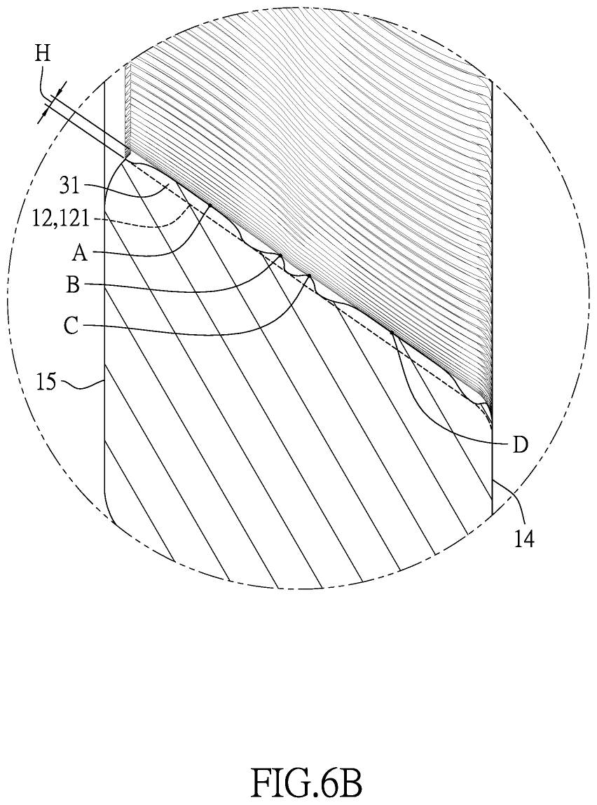

As shown in FIG. 4, the optical element 100 includes a ring body 10, which has an axis 11, an inner peripheral surface 12 surrounding the axis 11, an outer peripheral surface 13 opposite the inner peripheral surface 12, a first ring end surface 14 connecting the inner peripheral surface 12 and the outer peripheral surface 13, a second ring end surface 15 opposite the first ring end surface 14, and a stray light suppression structure 30 disposed on the inner peripheral surface 12; In this embodiment, as shown in FIGS. 5 to 6B, the inner peripheral surface 12 of the ring body 10 is gradually tapered from the first ring end surface 14 to the second ring end surface 15, and the inner peripheral surface 12 has an inner straight line 121 formed by a section in the direction of the axis 11. An included angle between the extension of the inner straight line 121 and the axis 11 is θ, and the θ is 35°, but is not limited thereto, also the following condition is satisfied: 25°<θ<65°, so as to improve the formability of the optical element 100.

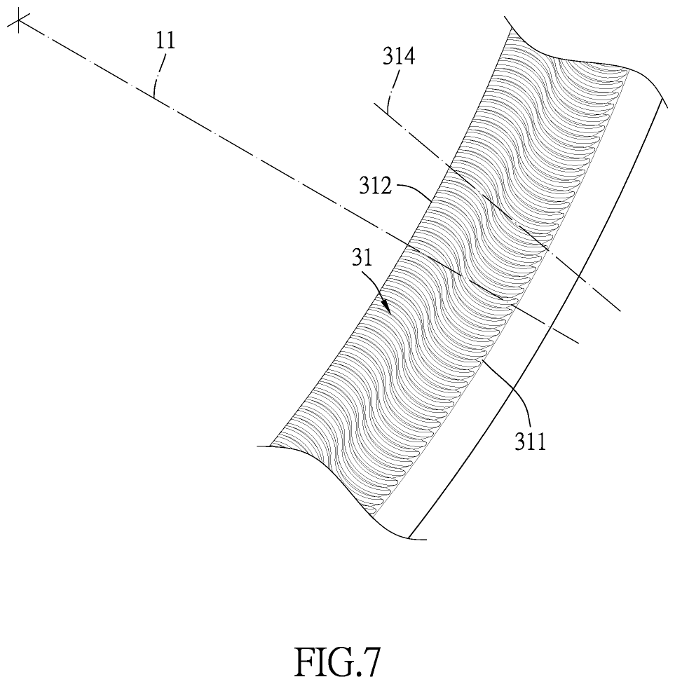

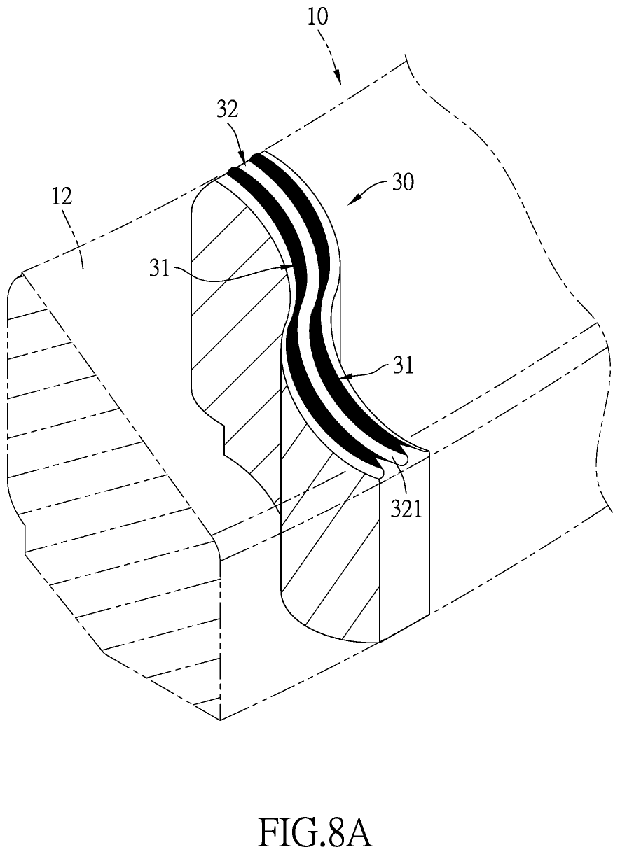

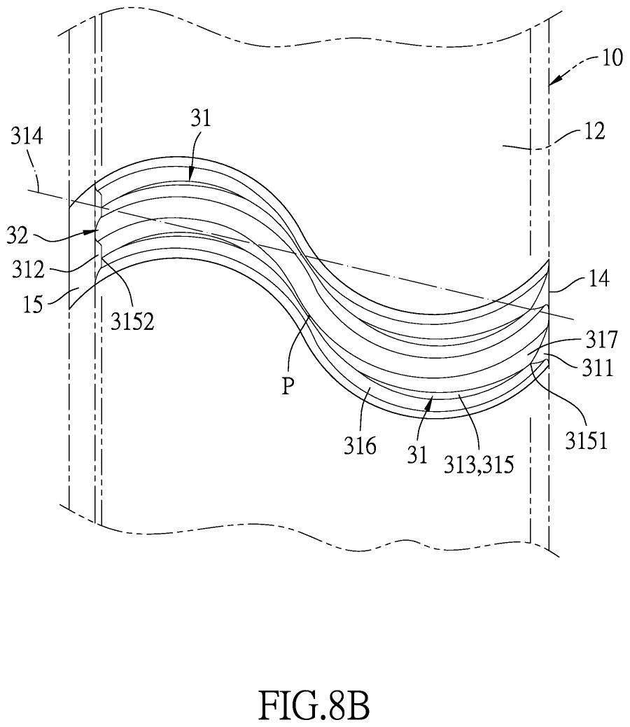

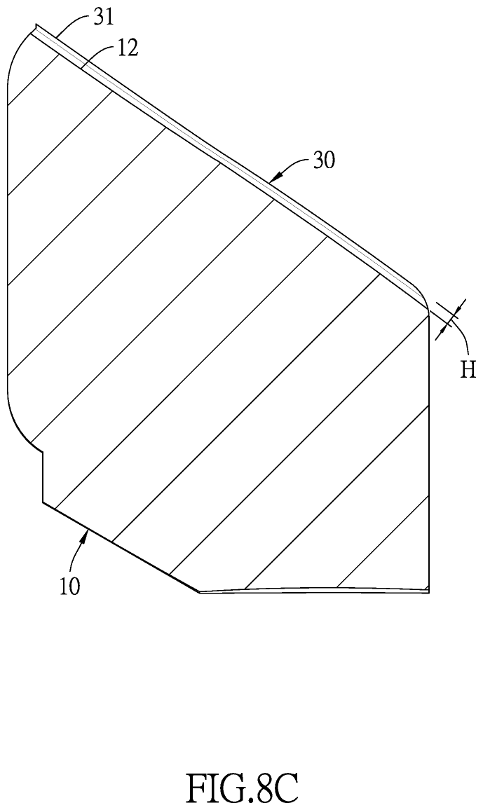

As shown in FIGS. 5 to 6B, the stray light suppression structure 30 includes a plurality of stray light suppression protrusions 31 surrounding the axis 11 and spaced on the inner peripheral surface 12, and a plurality of stray light suppression grooves 32 formed by the inner peripheral surface 12 and every two adjacent stray light suppression protrusions 31. Please also refer to FIG. 8A to FIG. 8C, which are simplified schematic diagrams of the first embodiment, only show the scenario that the ring body 10 has two stray light suppression protrusions 31 on the inner peripheral surface 12, and the two stray light suppression protrusions 31 are represented in black. Each stray light suppression protrusion 31 is a continuous structure that presents an S-shaped curve along the inner peripheral surface 12, and the stray light suppression protrusions 31 protrude from the inner peripheral surface 12 to the axis 11 at a same height H. Each stray light suppression protrusion 31 has a first stray light suppression end 311 connecting the first ring end surface 14, a second stray light suppression end 312 connecting the second ring end surface 15, a stray light suppression section 313 connected between the first stray light suppression end 311 and the second stray light suppression end 312, and a connecting line 314 passing through the first stray light suppression end 311 and the second stray light suppression end 312. The connecting line 314 does not coincide or intersect with the axis 11 (as shown in FIGS. 4 and 7). A bottom surface 321 of each of the stray light suppression grooves 32 is arc-shaped in the radial direction (as shown in FIG. 8A).

In addition, as shown in FIG. 8B, each stray light suppression protrusion 31 includes a reverse bend point P, and the stray light suppression section 313 of each stray light suppression protrusion 31 includes a stray light suppression top surface 315. The stray light suppression top surface 315 includes a first side 3151 adjacent to the first stray light suppression end 311, and a second side 3152 adjacent to the second stray light suppression end 312 and opposite to the first side 3151. The width of the stray light suppression top surface 315 gradually expands and then gradually reduces from the first side 3151 to the direction of the reverse bend point P, and the width of the stray light suppression top surface 315 gradually expands and then gradually reduces from the second side 3152 to the direction of the reverse bend point P. As shown in FIG. 8B, the stray light suppression section 313 of each stray light suppression protrusion 31 further includes a first stray light suppression side surface 316 connected to one side of the stray light suppression top surface 315, and a second stray light suppression side surface 317 connected to the other side of the stray light suppression top surface 315. The first stray light suppression side surface 316 and the second stray light suppression side surface 317 are arc-shaped in cross section in the radial direction.

Refer to FIG. 6A and FIG. 6B, where FIG. 6A shows that four of the stray light suppression protrusions 31 are represented by blackening, a section line 6B-6B passes through the four blackened stray light suppression protrusions 31, and the section line 6B-6B intersects at intersection points A, B, C, and D with the four stray light suppression protrusions 31, respectively, while FIG. 6B is the sectional view of FIG. 6A taken along the line 6B-6B, and the intersection points A, B, C, and D are marked. In design, an arbitrary axial section line (i.e. section line 6B-6B, and the section line 6B-6B is the same as the axis 11) of the ring body 10 passes through four stray light suppression protrusions 31 and three stray light suppression grooves 32, but is not limited thereto, as long as the axial section line can pass through at least two stray light suppression protrusions 31 and at least two stray light suppression grooves 32, so as to increase the number of the stray light suppression protrusions 31 and the stray light suppression grooves 32 on the inner peripheral surface 12 of the ring body 10, and more effectively eliminate the influence of stray light on imaging.

The above is the main structure description of the first embodiment of the invention, and the effects and function of the invention are as follows.

With reference to FIG. 3, when the optical element 100 is installed in the lens mount 21 and is used as a positioning ring 23 or spacer ring 24, in the actual imaging process, with the designs that both the stray light suppression protrusions 31 and the stray light suppression grooves 32 are designed as a continuous structure with a S-shaped curve (FIG. 8A), the stray light suppression protrusions 31 protrude from the inner peripheral surface 12 to the axis 11 at a same height H (as shown in FIG. 8A and FIG. 8C), the stray light suppression top surfaces 315 of the stray light suppression protrusions 31 are not equal in width (as shown in FIG. 8B), the first stray light suppression side surface 316 and the second stray light suppression side surface 317 of the respective stray light suppression protrusions 31 are arc-shaped (as shown in FIG. 8B), and the connecting line 314 passing through the first stray light suppression end 311 and the second stray light suppression end 312 of the S-shaped stray light suppression protrusions 31 do not coincide or intersect with the axis 11 (FIG. 7), thus a considerable number of irregular surfaces are provided to reflect stray light, making the reflecting directions of the reflection surfaces more multidirectional, and then the direction of the stray light can be deviated from the axis 11, so that the stray light can be scattered more dispersedly, so as to prevent the stray light from gathering and affecting the imaging.

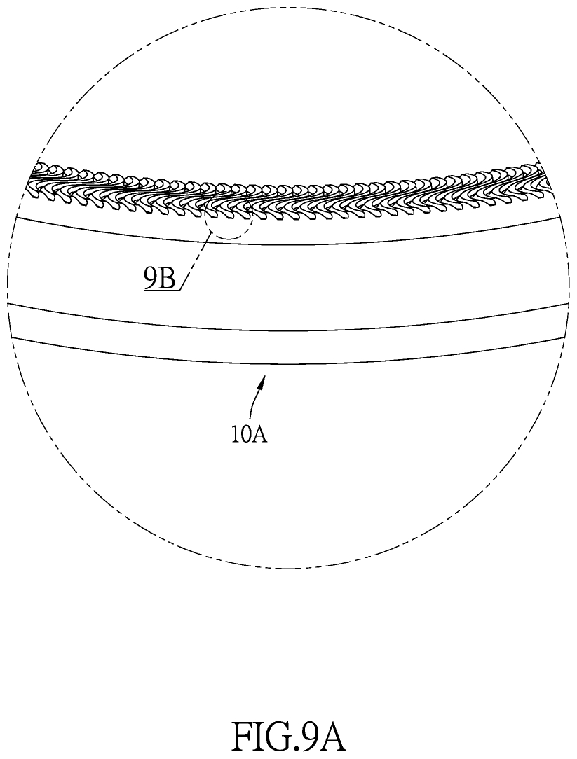

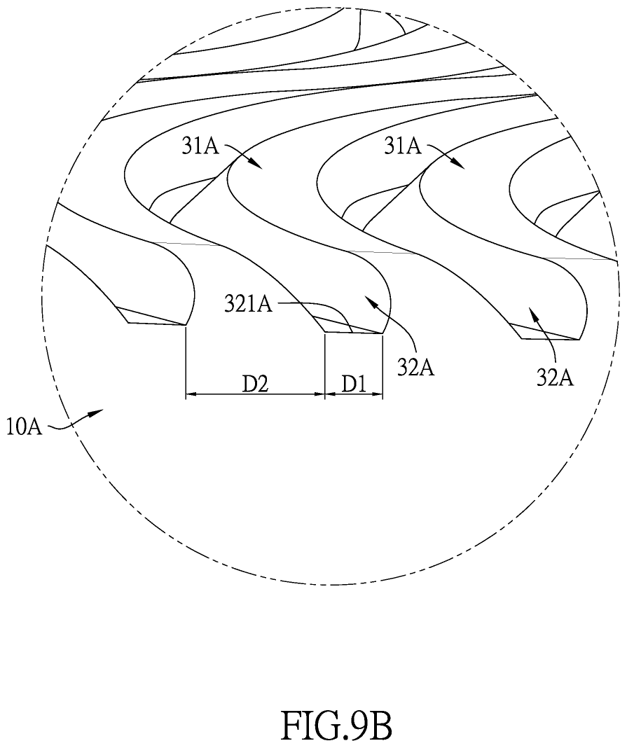

Referring to FIG. 9A and FIG. 9B, the second embodiment of the invention provides an optical element having stray light suppression structure, which differs from the first embodiment in that:

The bottom surface 321A of each stray light suppression grooves 32A of the ring body 10A presents a straight line in cross section in the radial direction, so as to provide reflection surfaces of more reflecting directions, so that stray light can be scattered more dispersedly, avoid the accumulation of stray light and affect the imaging. Furthermore, the distance between two adjacent stray light suppression protrusions 31A is D1, the width of the stray light suppression protrusions 31 is D2, and the following conditions are met: D1/(D1+D2)=0.706, but are not limited thereto, as along as the condition is met: 0.2<D1/(D1+D2)<1.0, to eliminate most stray light.

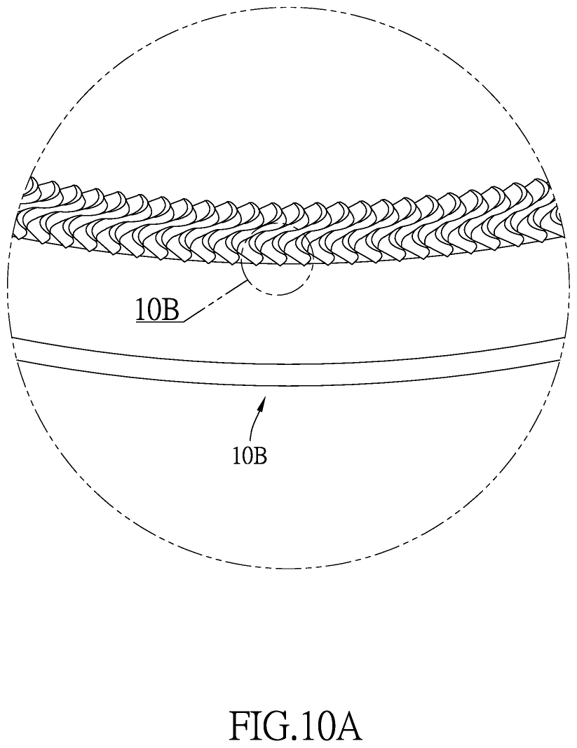

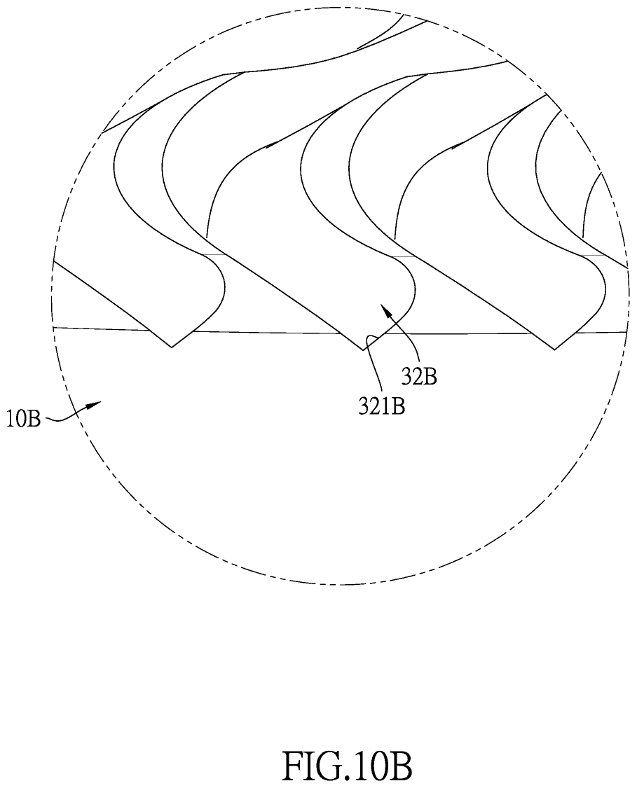

Referring to FIG. 10A and FIG. 10B, the third embodiment of the invention provides an optical element having stray light suppression structure, which differs from the first embodiment in that:

The bottom surface 321B of each stray light suppression groove 32B of the ring body 10B presents a V shape in cross section in the radial direction, so as to provide reflection surfaces of more reflecting directions, so that stray light can be scattered more dispersedly, avoid the accumulation of stray light and affect the imaging.

What is claimed is:

1. An optical element having stray light suppression structure, comprising:
a ring body including an axis, an inner peripheral surface surrounding the axis, an outer peripheral surface opposite the inner peripheral surface, a first ring end surface connecting the inner peripheral surface and the outer peripheral surface, a second ring end surface opposite the first ring end surface, and a stray light suppression structure disposed on the inner peripheral surface;
wherein the inner peripheral surface has an inner straight line formed by a cross section in the direction of the axis, and an included angle between an extension of the inner straight line and the axis is θ, and the following condition is satisfied: 25°<θ<65°;
the stray light suppression structure includes a plurality of stray light suppression protrusions surrounding the axis and spaced on the inner peripheral surface, and a plurality of stray light suppression grooves formed by the inner peripheral surface and every two adjacent stray light suppression protrusions, each of the stray light suppression protrusions is a continuous structure that presents an S-shaped curve, the stray light suppression protrusions protrude from the inner peripheral surface at a same height, each of the stray light suppression protrusions includes a first stray light suppression end connecting the first ring end surface, a second stray light suppression end connecting the second ring end surface, a stray light suppression section connected between the first stray light suppression end and the second stray light suppression end, and a connecting line passing through the first stray light suppression end and the second stray light suppression end, and the connecting line does not coincide or intersect with the axis.

2. The optical element having stray light suppression structure as claimed in claim 1, wherein the inner peripheral surface of the ring body is tapered from the first ring end surface to the second ring end surface.

3. The optical element having stray light suppression structure as claimed in claim 1, wherein an arbitrary axial section line passes through at least two of the stray light suppression protrusions and at least two of the stray light suppression grooves.

4. The optical element having stray light suppression structure as claimed in claim 1, wherein each of the stray light suppression protrusions includes a reverse bend point.

5. The optical element having stray light suppression structure as claimed in claim 4, wherein the stray light suppression section of each of the stray light suppression protrusions includes a stray light suppression top surface, the stray light suppression top surface includes a first side adjacent to the first stray light suppression end, and a second side adjacent to the second stray light suppression end and opposite to the first side, a width of the stray light suppression top surface expanded then reduced from the first side to the reverse bend point, and a width of the stray light suppression top surface expanded then reduced from the second side to the reverse bend point.

6. The optical element having stray light suppression structure as claimed in claim 1, wherein a bottom surface of each of the stray light suppression grooves is arc-shaped in cross section in a radial direction.

7. The optical element having stray light suppression structure as claimed in claim 1, wherein a bottom surface of each of the stray light suppression grooves presents a straight line in cross section in a radial direction.

8. The optical element having stray light suppression structure as claimed in claim 7, wherein a distance between two adjacent said stray light suppression protrusions is D1, a width of the stray light suppression protrusions is D2, and the following condition is satisfied: 0.2<D1/(D1+D2)<1.0.

9. The optical element having stray light suppression structure as claimed in claim 1, wherein a bottom surface of each of the stray light suppression grooves presents a V shape in cross section in a radial direction.
